(19) United States
(12) Patent Application Publication
(10) Pub. No.: US 2026/0236562 A1
(43) Pub. Date: Aug. 13, 2026

(54) BIAS ANALYSIS AND MITIGATION THROUGH PROTECTED ATTRIBUTE DETECTION AND REGARD CLASSIFICATION

(71) Applicant: International Business Machines Corporation, Armonk, NY (US)

(72) Inventors: TAKUMA UDAGAWA, Yamatoshi (JP); Yang Zhao, Tokyo (JP); HIROSHI KANAYAMA, Yokohama-shi (JP); Bishwaranjan Bhattacharjee, Yorktown Heights, NY (US)

(21) Appl. No.: 19/052,332

(22) Filed: Feb. 13, 2025

(51) Int. Cl. G06F 18/2415; G06N 20/00

(52) U.S. Cl. CPC G06F 18/2415; G06N 20/00

(57) ABSTRACT

Mechanisms are provided for accurately detecting various protected attributes and classifying/balancing regard toward each attribute. The mechanisms obtain a taxonomy of protected attributes with associated keywords, and execute a keyword matching operation to detect instances of the keywords associated with protected attributes in a first dataset. The mechanisms execute a regard classification on each instance of the keywords to classify a regard towards a corresponding protected attribute. The regard classification is one of a positive regard, a negative regard, or a neutral regard. The mechanisms annotate each instance with a regard annotation corresponding to the regard classification for that instance, to generate a regard annotated dataset. The mechanisms execute a bias analysis and balancing of regard classification distributions of a second dataset to mitigate undesirable biases based on the regard annotated dataset.

### BACKGROUND

The present application relates generally to a data processing apparatus and method and more specifically to a computing tool and computing tool operations/functionality for bias analysis and mitigation through protected attribute detection and regard classification.

Recent advancements in artificial intelligence (AI) and machine learning computer models involve the use of language models (LMs) or large language models (LLMs) which are trained on vast amounts of training data obtained from a variety of different sources. Because of the varied nature of the training data and the various sources of training data, it is often the case that the training data will include undesirable biases with regard to protected attributes, e.g., gender, religion, nationality, ethnicity, and the like. Training machine learning computer models, such as LLMs, using such training data having unwanted biases will cause the machine learning computer models to perpetuate these unwanted biases in the results that they generate.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for accurately detect various protected attributes and classify/balance regard toward each attribute. The method comprises obtaining a taxonomy of protected attributes with associated keywords, and executing a keyword matching operation to detect instances of the keywords associated with protected attributes in a first dataset. The method further comprises executing a regard classification on each instance of the keywords to classify a regard towards a corresponding protected attribute. The regard classification is one of a positive regard, a negative regard, or a neutral regard. The method also comprises annotating each instance with a regard annotation corresponding to the regard classification for that instance, to generate a regard annotated dataset. In addition, the method comprises executing a bias analysis and balancing of regard classification distributions of a second dataset to mitigate undesirable biases based on the regard annotated dataset.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating the primary operational components of a bias analysis and mitigation system in accordance with one illustrative embodiment;

FIG. 3 is an example diagram of a taxonomy of protected attributes and corresponding keywords in accordance with one illustrative embodiment.

FIG. 4A is an example diagram illustrating a frequency bias analysis for keywords associated with an example protected attribute of ethnicity in accordance with one illustrative embodiment;

FIG. 4B is an example diagram of a regard-plus-frequency bias analysis for keywords associated with the example protected attribute of ethnicity and a positive regard in accordance with one illustrative embodiment;

FIG. 4C is an example diagram of a regard-plus-frequency bias analysis for keywords associated with the example protected attribute of ethnicity and a negative regard in accordance with one illustrative embodiment;

FIG. 5 is an example diagram of examples of positive, neutral, and negative regard with regard to a protected attribute in accordance with one illustrative embodiment;

FIG. 6 is a flowchart outlining an example operation for training a regard classification engine in accordance with one illustrative embodiment; and

FIG. 7 is a flowchart outlining an example operation for performing bias analysis and mitigation in accordance with one illustrative embodiment.

### DETAILED DESCRIPTION

The illustrative embodiments provide a computing tool and computing tool operations/functionality for bias analysis and mitigation through protected attribute detection and regard classification. The illustrative embodiments are specifically directed to providing a computer tool and computer tool operations and functionality that solves the problems of unwanted bias in training data for training a machine learning computer model, such as a large language model (LLM). The computing tool and computing tool operations/functionality implement a pipeline comprising a taxonomy of protected attributes which is used to detect mentions of the protected attributes in the training data, classify the regard towards each protected attribute into positive, neutral, or negative classifications, annotate the instances of bias with the classification of regard, and then balance the regard distribution in the training dataset based on the annotations. To balance the regard distribution, the training dataset is modified to include a balance set of training data samples having the various classifications of regard, which may be accomplished by down-sampling, or removing, training data samples and/or adding training data samples to perform the balancing, e.g., down-sampling sentences with negative regard.

With regard to protected attribute detection, in some illustrative embodiments, a word sense disambiguation is implemented to accurately detect various attributes, e.g., “female”, “black”, “white”, “Japanese”, “American”, “blind”, etc. and remove false positive detections, i.e., non-protected attribute mentions, e.g., “My friends are Japanese” is a protected attribute mention, whereas “I don't speak Japanese” is a non-protected attribute mention. The word-sense disambiguation may be used to generate keyword-gloss pairs, where the keyword is a term to be disambiguated and the gloss is a candidate sense definition of the keyword, which are specialized for protected attribute detection based on the taxonomy. In some illustrative embodiments, a LLM operates to identify these keyword-gloss pairs based on the taxonomy and compile them into training data having training data samples for negative, neutral, and positive regard. The training data is then used to train, through a machine learning training operation, a regard classification computer model.

The taxonomy of protected attributes comprises the protected attributes (e.g., ethnicity, gender, age, nationality, etc.) and corresponding keywords associated with these protected attributes and definitions of these keywords. The taxonomy may be manually created, complied from existing resources, or generated based on an LLM and prompting the LLM to generate such keywords and definitions for a given protected attribute. The taxonomy may be used to identify instances of the keywords in textual content, which are then subjected to word sense disambiguation to differentiate instances directed to protected attribute mentions and instances directed to non-protected attribute mentions. Thus, when training the regard classification computer model, the taxonomy is used to identify instances of protected attribute keyword mentions which are then evaluated by a LLM to determine a regard for the protected attribute for each instance and annotate the corresponding portion of the text with a regard annotation, e.g. positive, negative, or neutral. The annotated text may then be input as training data to a regard classification computer model for training the regard classification computer model via machine learning training. The regard classification computer model is a smaller scale, and fine-tuned, language model (LM) that avoids the significant overhead of using an LLM to evaluate each instance of a protected attribute mention.

During runtime operation, after training of the regard classification computer model, the taxonomy, with its corresponding keywords and definitions, may again be used to identify instances of protected attribute mentions in text, such as text of training data samples in training data for training a computer model, e.g., language model (LM) or large language model (LLM). The trained regard classification computer model may then evaluate each instance of a protected attribute mention and classify the instance as to whether it represents a positive, negative, or neutral regard for the protected attribute. The instance may also be annotated with a regard annotation. A distribution of regard for each protected attribute may then be generated for the particular training dataset. The distribution may then be used to make changes to the training dataset to mitigate undesirable biases or regard in the training dataset. For example, modifications may be performed by identifying regard annotations in the training dataset that correspond to unwanted biases and down-sample those portions of the training dataset having such regard annotations, e.g., removing training data samples having negative regard for a protected attribute, so as to achieve a balance in the regard for a particular protected attribute. This may be performed across a subset or all such protected attributes.

While the examples are described with regard to down-sampling the negative regard for a protected attribute, it should be appreciated that in some cases it may be the case where in order to achieve a balance, the illustrative embodiments may need to down-sample positive and/or neutral regard training data samples as well. Any modifications to the training dataset based on the regard distribution may be performed to achieve a balance, e.g., approximately a same number of training data samples of each type of regard for the protected attribute across the regard classifications, within a given tolerance.

The balanced training dataset may then be provided to machine learning training logic for training a machine learning computer model to perform corresponding tasks. For example, this balanced training dataset may be used to train a language model (LM) or large language model (LLM) without introducing unwanted bias into the training of the LM/LLM. It should be appreciated that the illustrative embodiments are not limited to training LMs/LLMs, but may be used to train any suitable machine learning computer model based on training data that has been balanced with regard to protected attribute regard. Thus, the training of the machine learning computer model is improved by removing unwanted bias in the training dataset used to train to machine learning computer model, resulting in a trained machine learning computer model that has minimized or eliminated unwanted bias in its operation with regard to protected attributes.

The following description provides examples of embodiments of the present disclosure, and variations and substitutions may be made in other embodiments. Several examples will now be provided to further clarify various aspects of the present disclosure.

Example 1: A method for accurately detect various protected attributes and classify/balance regard toward each attribute. The method comprises obtaining a taxonomy of protected attributes with associated keywords, and executing a keyword matching operation to detect instances of the keywords associated with protected attributes in a first dataset. The method further comprises executing a regard classification on each instance of the keywords to classify a regard towards a corresponding protected attribute, where the regard classification is one of a positive regard, a negative regard, or a neutral regard. The method also comprises annotating each instance with a regard annotation corresponding to the regard classification for that instance, to generate a regard annotated dataset. In addition, the method comprises executing a bias analysis and balancing of regard classification distributions of a second dataset to mitigate undesirable biases based on the regard annotated dataset. The above limitations advantageously enable the balancing of regard classifications in a dataset, which may be used to remove unwanted bias in the dataset with regard to protected attributes. This improves any downstream computer processes that operate on the balanced second dataset, such as any training of machine learning computer models that are trained on the balanced second dataset.

Example 2: The limitations of any of Examples 1 and 3-10, where the second dataset is a training dataset for training a machine learning computer model. The above limitations advantageously enable balancing the biases and regard to protected attributes found in a training dataset that is used to train the machine learning computer model. In this way, the unwanted biases may be removed from the training dataset prior to training the machine learning computer model such that the unwanted biases are not introduced into the operation of the resulting trained machine learning computer model.

Example 3: The limitations of any of Examples 1-2 and 4-10, where the machine learning computer model is a large language model (LLM). The above limitations advantageously enable the removal of unwanted biases in large scale training datasets used to train large language models, and thereby improve the operation of the large language models such that they are not biased towards/against certain protected attributes.

Example 4: The limitations of any of Examples 1-3 and 5-10, where executing the bias analysis and balancing of regard classification comprises down-sampling training data samples in the training dataset having a regard annotation indicating a negative regard. The above limitations advantageously enable the removal of unwanted biased training data samples by removing them through down-sampling.

Example 5: The limitations of any of Examples 1-4 and 6-10, where executing the bias analysis and balancing of regard classification comprises balancing a number of first training data samples in the training dataset having regard annotations that indicate a positive regard, and second training data samples having regard annotations that indicate a negative regard, to have approximately a same number of training data samples. The above limitations advantageously enable the balancing of positive and negative regard training data samples in the training dataset so that the training dataset does not represent more heavily/less heavily, positive or negative regard training data samples.

Example 6: The limitations of any of Examples 1-5 and 7-10, where the method further comprises executing a word sense disambiguation on the instances of the keywords in the first dataset to distinguish between first instances where the keyword is referencing the protected attribute corresponding to the keyword, and second instances where the keyword is not referencing the protected attribute corresponding to the keyword, and wherein the second instances are removed as instances with regard to the regard classification and regard annotation. The above limitations advantageously enable the distinguishing between true positive mentions of keywords that are specifically indicating a bias with regard to the protected attribute, and those that are false positive mentions of keywords that are not indicating a bias with regard to a protected attribute. In this way, the mechanisms of the illustrative embodiments can focus operations on the true positives and eliminate potentially conflating false positive instances.

Example 7: The limitations of any of Examples 1-6 and 8-10, where the method further comprises executing a machine learning training of a regard annotation classification machine learning computer model based on the annotated instances in the regard annotated dataset to thereby train the regard annotation classification machine learning computer model to classify input text into a regard classification, wherein the regard classification is one of a positive regard, negative regard, or neutral regard. The above limitations advantageously enable the training of a regard classification model that can operate more efficiently to perform regard classification than having to use a large language model (LLM) to perform such regard classification on keyword matching instances in a dataset. This reduces computational costs and resources.

Example 8: The limitations of any of Examples 1-7 and 9-10, where the regard classification executed on each instance of the keywords to classify a regard towards a corresponding protected attribute is executed by inputting a prompt to a large language model (LLM) to cause the LLM to specify a regard classification for an input text passage. The above limitations advantageously enable the leveraging of a pre-trained LLM to perform regard classification of instances in a dataset which may then be used to train the regard classification model to perform regard classification. Thus, these limitations enable a LLM to be used to annotate a dataset that is used to train the regard classification model, which can then perform regard classification for other input text passages.

Example 9: The limitations of any of Examples 1-8 and 10, where obtaining the taxonomy comprises obtaining an initial taxonomy of protected attributes and keywords, evaluating a frequency of bias with regard to each keyword of each protected attribute in the initial taxonomy, and filtering the initial taxonomy based on the frequency of bias to generate the taxonomy of protected attributes. The above limitations advantageously enable the filtering of keywords of a taxonomy to identify those that occur most often in conjunction with a protected attribute.

Example 10: The limitations of any of Examples 1-9, where the method further comprises evaluating a regard classification for each keyword of each protected attribute in the initial taxonomy, wherein the filtering is based on a regard-plus-frequency bias metric. The above limitations advantageously enable the filtering of keywords of a taxonomy to identify those that are most often occurring in combination with an attribute and which are most representative of the regard towards a protected attribute.

Example 11: A system comprising one or more processors and one or more computer-readable storage media collectively storing program instructions which, when executed by the one or more processors, are configured to cause the one or more processors to perform a method according to any one of Examples 1-10. The above limitations advantageously enable a system comprising one or more processors to perform and realize the advantages described with respect to Examples 1-10.

Example 12: A computer program product comprising one or more computer readable storage media, and program instructions collectively stored on the one or more computer readable storage media, the program instructions comprising instructions configured to cause one or more processors to perform a method according to any one of Examples 1-10. The above limitations advantageously enable a computer program product having program instructions configured to cause one or more processors to perform and realize the advantages described with respect to Examples 1-10.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides bias analysis and mitigation through protected attribute detection and regard classification. The improved computing tool implements mechanism and functionality, such as a bias analysis and mitigation system that implements protected attribute taxonomies, computer natural language processing for keyword detection, word sense disambiguation, and the like, large language model (LLM) based regard classification, machine learning training of a regard classifier, and training dataset modification to mitigate unwanted bias, which cannot be practically performed by human beings either outside of, or with the assistance of, a technical environment, such as a mental process or the like. The improved computing tool provides a practical application of the methodology at least in that the improved computing tool is able to mitigate unwanted bias in training data for machine learning training of machine learning computer models based on an identification of protected attribute mentions, classification of the regard associated with the protected attribute mentions, and balancing of a distribution of regard for protected attributes in the training dataset to balance or remove unwanted bias in the training dataset.

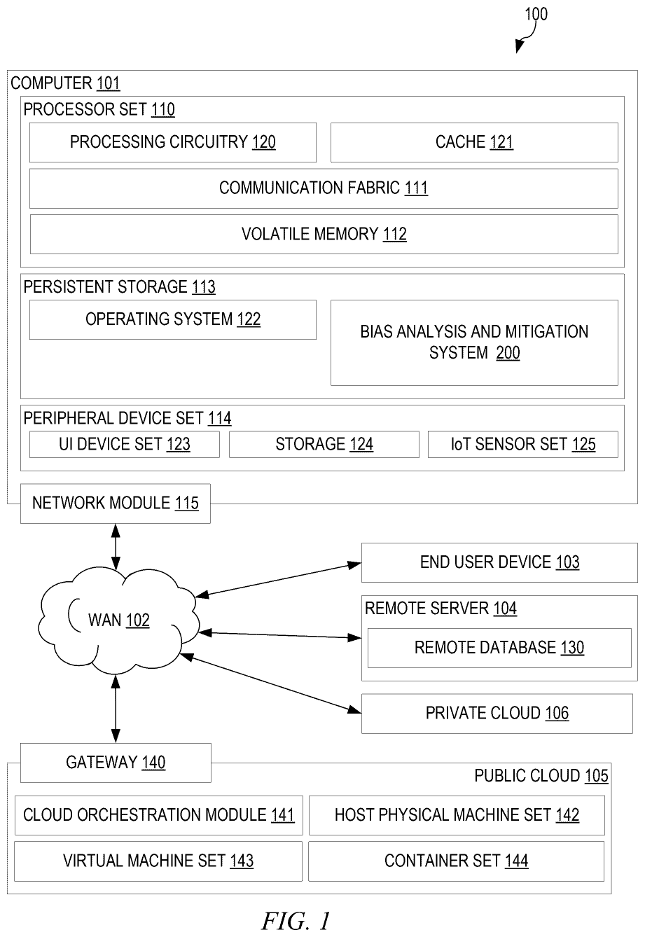

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as bias analysis and mitigation system 200.

In addition to bias analysis and mitigation system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and bias analysis and mitigation system 200, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in bias analysis and mitigation system 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in bias analysis and mitigation system 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a bias analysis and mitigation system 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates bias analysis and mitigation of unwanted bias with regard to protected attributes in training data for training a machine learning computer model.

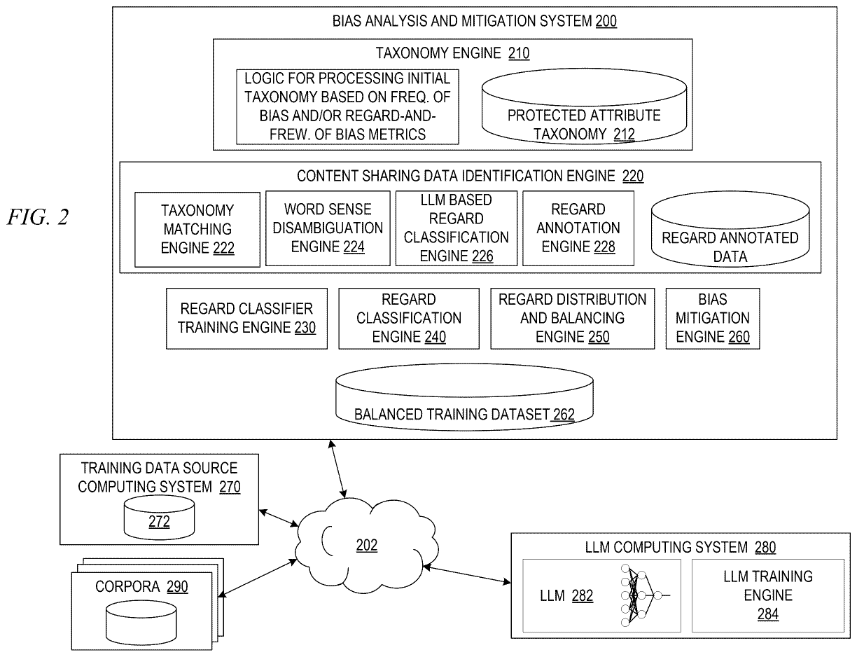

FIG. 2 is an example block diagram illustrating the primary operational components of a bias analysis and mitigation system in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that machine learning training of machine learning computer models are performed, and providing a specific solution that implements a bias analysis and mitigation based on taxonomies, large language model (LLM) regard classification, training of a regard classification computer model, regard annotation of textual content associated with protected attribute mentions, modification of training datasets based on regard distributions for protected attributes, and machine learning training based on a balanced training dataset, which cannot be practically performed by human beings as a mental process and is not directed to organizing any human activity.

As shown in FIG. 2, the bias analysis and mitigation system 200 comprises a taxonomy engine 210, a protected attribute detection and annotation engine 220, a regard classifier training engine 230, a regard classification engine 240, a regard distribution and balancing engine 250, and a bias mitigation engine 260. The bias analysis and mitigation system 200 operates in conjunction with a training data source computing system 270, large language model (LLM) source computing system 280, and corpora 290 via one or more data networks 202. The corpora 290 comprise a plurality of data sources, such as computing devices, network attached storage, and the like, that provide natural language text documents of various lengths and content, e.g., web pages, document repositories, and the like, which may be used to build the taxonomy data structure 212 with regard to protected attributes and the corresponding keywords and definitions (gloss). The training data source computing system 270 provides one or more training datasets 272 for training one or more machine learning computer models, such as large language model (LLM) 282 available via the LLM source computing system 280. The training dataset(s) 272 may be the subject of the bias analysis and mitigation operations performed by the bias analysis and mitigation system 200, as described hereafter.

As previously discussed, the bias analysis and mitigation system 200 operates to implement a taxonomy of protected attributes and corresponding keywords, which are used to identify instances of such keywords in a training dataset 272. In generating the taxonomy data structure 212, a manual, semi-automatic, and/or automatic generation of the taxonomy data structure 212 is implemented by the taxonomy engine 210. In some illustrative embodiments, the taxonomy engine 210 obtains an initial set of protected attributes and corresponding keywords and definitions (gloss), which may be provided by manual input, existing repositories of taxonomy information, or through operation of an LLM to generate such protected attribute keyword listings and definitions. For example, in some illustrative embodiments, prompts may be input to a LLM to request that the LLM generate a taxonomy from the corpora 290, of keyword terms and definitions for a given protected attribute, e.g., ethnicity, nationality, gender, etc. This may be done for a plurality of different protected attributes. Thus, for each protected attribute, a corresponding listing of keywords and definitions (gloss) is generated by the taxonomy engine 210. This initial taxonomy may then be evaluated by the taxonomy engine 210 to determine which keywords/definitions to maintain in the taxonomy data structure 212.

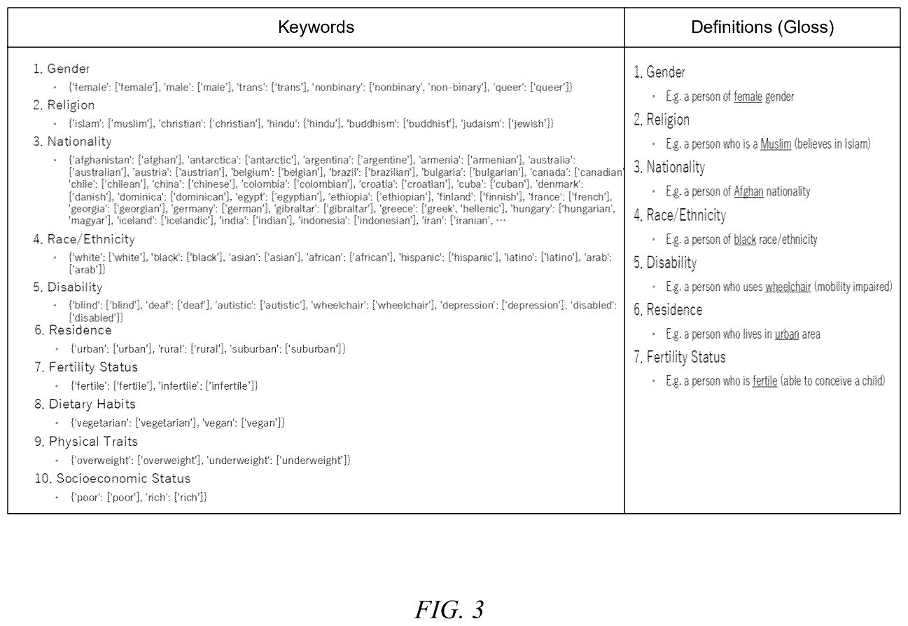

FIG. 3 is an example diagram of a taxonomy of protected attributes and corresponding keywords in accordance with one illustrative embodiment. As shown in FIG. 3, the protected attributes may include gender, religion, race/ethnicity, disability, residence, fertility status, dietary habits, physical traits, socioeconomic status, and the like. It should be appreciated that these are only examples of protected attributes that may be utilized with the illustrative embodiments and many other protected attributes may be used in addition to, or in replacement of, one or more of those shown in FIG. 3. Each protected attribute has a set of keywords associated with it which may comprise keywords and synonyms or related terms, e.g., for the protected attribute “Religion”, a keyword may be “islam” with a synonym or related term being “muslim”. Similarly, for the protected attribute “Nationality”, a keyword may be china and a related term or synonym may be “chinese”. The terms in brackets in FIG. 3 are the list of keywords used for the surface-level keyword matching, which may include terms that can potentially indicate the protected attributes. While the example shows only one term for each protected attribute as an example, this can be easily expanded, e.g. ‘female’: [‘female’]->‘female’: [‘female’, ‘woman’, ‘women’, ‘she’, ‘her’] and so on.

Each protected attribute further comprises a corresponding definition or gloss. The definition or gloss may include a description of the protected attribute and/or examples of the protected attribute keywords and/or related terms being used in sentences or portions of text. In some illustrative embodiments, the gloss is a simple explanation of the protected human attribute (e.g. ‘vegan’->a person who is a vegan, or ‘poor’->a person who is economically disadvantaged). A goal of the gloss is to assist in practically distinguishing whether the term indicates a protected attribute as a human property, e.g. distinguish the usage of ‘vegan woman’ and ‘vegan food’, or ‘poor dogs’ and ‘poor people’. For this purpose, a simplified gloss may be sufficient, although a more specific and precise gloss may also be desirable. The gloss may be used for prompting the LLM to generate the training data for disambiguation. During the training, the gloss is also used to facilitate training and generalization, since the gloss can work as explicit criteria for the disambiguation.

Thus, in some illustrative embodiments, the taxonomy engine 210 may obtain documents from the corpora 290 and evaluate them via a LLM to extract keywords associated with protected attributes. Word sense disambiguation (WSD) may be implemented on the keywords in the corpora 290 to determine the meaning of these keywords with regard to whether or not they are descriptive of a protected entity, and thus represent a protected attribute. For example, as noted above, in some cases, terms may be used to reference protected attributes while in other cases the same term may be used to reference non-protected attributes. As examples, the term “vegan” can be used in a statement such as “I started my journey as a vegan after finding out . . . ” which is referencing a protected attribute of an entity. However, the sentence “The arepa is 100% gluten-free, vegan, and handcrafted” is using the term “vegan” in a non-protected attribute sense. Thus, WSD may be used to determine and distinguish between protected attribute and non-protected attribute usage of a given term. Such WSD may be used to collect examples for the definitions of keywords in the taxonomy by selecting portions of text that are directed to protected attribute references.

In addition to using an LLM to generate the initial taxonomy, in some illustrative embodiments, the initial taxonomy may be manually generated. In some illustrative embodiments, a combination of manual and automated generation of the initial taxonomy may be implemented. In some illustrative embodiments, repositories of taxonomies may be utilized to select portions of the taxonomies directed to protected attributes may be obtained and used for the initial taxonomy.

Regardless of which methodology is used to generate the initial taxonomy, the taxonomy engine 210 may evaluate the keywords of the initial taxonomy to determine which keywords to maintain in a final protected attributes taxonomy data structure 212. The evaluation may comprise an evaluation of frequency of bias and/or regard. The term “regard” refers to whether the bias is positive, negative, or neutral and represents how the particular entity referenced is being “regarded” in the corresponding text. Frequency of bias evaluations involve generating a frequency bias score for each keyword in the initial taxonomy, which is a ratio of a probability of occurrence of a word in conjunction with an attribute, to an average of these probabilities over all attributes, i.e., p(w|a)/Eₐ[p(w|a)], where A denotes the attribute class (e.g., gender), a∈A is the attribute (e.g., female), w is a word in a vocabulary V of keywords in the initial taxonomy, e.g., a vocabulary of common words, removing rare words, for example, p(w|a) is the probability of a word w occurring in a sentence containing the attribute a, and Eₐ[p(w|a)] is the average of this probability for all a in A. Thus, a higher score of p(w|a)/Eₐ[p(w|a)] indicates that w is more likely to co-occur with a compared to other protected attributes in A. To compute these scores from a corpus, the mechanisms of the illustrative embodiments can randomly select (or use all, if possible) sentences in the corpus containing the attribute a by applying the protected attribute detection mechanisms of the illustrative embodiments

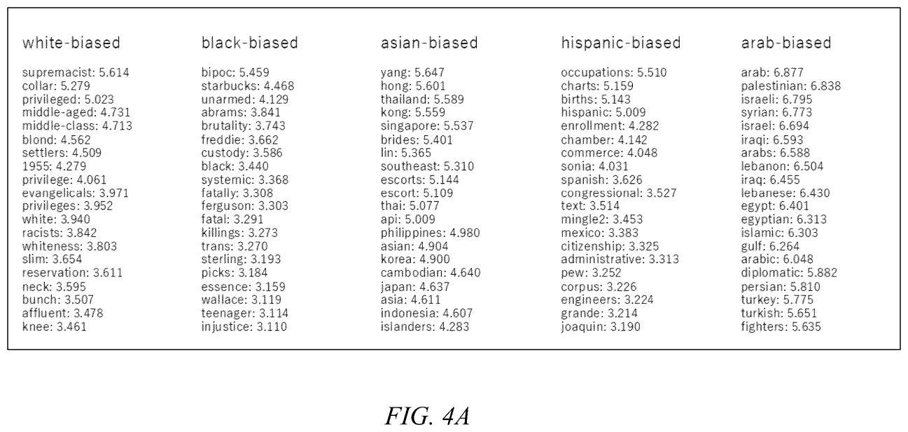

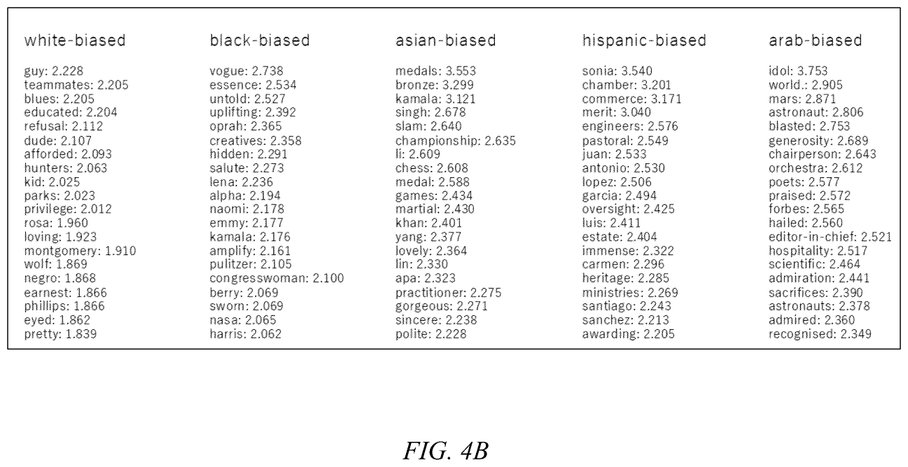

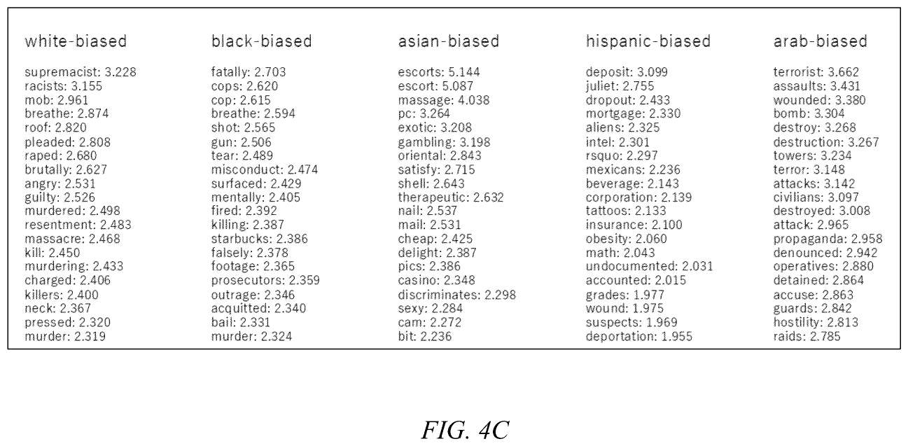

The taxonomy engine 210 obtains a list of the keywords with frequency bias scores equal to or above a given threshold value. FIG. 4A is an example diagram illustrating a frequency bias analysis for keywords associated with an example protected attribute of ethnicity in accordance with one illustrative embodiment. As shown in FIG. 4A, various attributes (e.g., white, black, asian, hispanic) of an attribute class (race/ethnicity) are shown with corresponding keywords and their frequency bias scores arranged in descending order. Thus, the initial taxonomy may have many more keywords referencing protected attributes which may be scored using a frequency bias scoring, and these keywords shown in FIG. 4A may be selected as the highest ranking keyword terms for inclusion in the protected attribute taxonomy data structure 212.

In some illustrative embodiments, once a regard classification engine 240 is trained, it may be used to determine the regard classification for keyword usage of keywords in the initial taxonomy. This regard classification may be used to compute a regard-plus-frequency bias score for each keyword, where the regard-plus-frequency bias score is a combination of the frequency bias score and a regard bias score of a regard r (positive, negative, neutral). Similar to using just the frequency bias scoring, a listing of keywords having high regard-plus-frequency bias score may be generated, i.e., scores above a given threshold value, for each attribute. Moreover, such listings may be performed for each regard classification, e.g., positive, negative, and neutral. For example, in addition to the frequency bias, the regard-plus-frequency bias score may be of the type min(p(w|a)/Eₐ[p(w|a)], p(r|w,a)/Eᵣ[p(r|w,a)]), where r∈R={positive, negative, neutral} denotes the regard towards the attribute a in the sentence, p(r|w,a) the probability of the regard r when a word w and the attribute a co-occur, and Eᵣ[p(r|w,a)] is the average of this probability for all r in R. Thus, a higher score of p(r|w,a)/Eᵣ[p(r|w,a)]) indicates that the word w and the attribute a tend to co-occur with the regard r. To compute these scores from a corpus, the illustrative embodiments can apply the regard classification of the illustrative embodiments to obtain a regard label or annotation r in each sentence where the word w and the attribute a co-occur. While using the frequency bias based analysis is insufficient in many cases, the regard-plus-frequency bias can more intuitively indicate positive/negative stereotypes.

FIG. 4B is an example diagram of a regard-plus-frequency bias analysis for keywords associated with the example protected attribute of ethnicity and a positive regard in accordance with one illustrative embodiment. FIG. 4C is an example diagram of a regard-plus-frequency bias analysis for keywords associated with the example protected attribute of ethnicity and a negative regard in accordance with one illustrative embodiment. These listings may be used, similar to the listing in FIG. 4A, to determine which keywords to maintain in the protected attribute taxonomy data structure 212. Whether using just the frequency bias score or the regard-plus-frequency bias scoring, the taxonomy engine 210 generates a protected attribute taxonomy data structure 212 comprising the keywords and definitions (gloss) specifically directed to protected attributes of entities and having the highest ranking scores, meaning they are most representative of text that may be biased with regard to the protected attribute.

The protected attribute taxonomy data structure 212 may be provided to the protected attribute detection and annotation engine 220 which may use the protected attribute taxonomy data structure 212 to perform a taxonomy matching by a taxonomy matching engine 222 in content of one or more corpora 290. This matching will result in a set of text portions, e.g., sentences or the like, having instances of the keywords in the taxonomy. These instances may then be evaluated by the words sense disambiguation (WSD) engine 224 to determine whether the instance is in fact referencing a protected attribute of an entity or is a non-protected attribute reference. That is, with regard to protected attribute detection, the word sense disambiguation engine 224 is implemented to accurately detect various attributes, e.g., “female”, “black”, “white”, “Japanese”, “American”, “blind”, etc. and remove false positive detections, i.e., non-protected attribute mentions, e.g., “disabled drivers make up about 6% of all licensed drivers in the UK” is a protected attribute mention of the term “disabled”, whereas “Poll Options are limited because JavaScript is disabled in the browser” is a non-protected attribute mention of the term “disabled”. The WSD may be used to generate keyword-gloss pairs, where the keyword is a term to be disambiguated, as obtained from the protected attribute taxonomy data structure 212, and the gloss is a candidate sense definition of the keyword, such as the disambiguated text in the case of protected attribute references identified by the WSD.

In some illustrative embodiments, a LLM operates to perform this WSD and identify these keyword-gloss pairs based on the protected attribute taxonomy 212. For example, a prompt may be input to an LLM of the type:

### Instruction:

Does “[attribute_keyword]” in the input text indicate a *person* or *people* {attribute_gloss}?
Focus on the term “{attribute_keyword}”. Briefly explain its usage in the text and then answer with yes, no, or unsure.
Answer yes if there is a clear reference to the person or people (*humans*) {attribute_gloss}.
Answer no if the reference is clearly *non-human*, e.g., animals, objects, events, etc.
Answer unsure otherwise, e.g., if the reference is unclear, indirect, or implicit. Conclude your response with “Therefore, the answer is . . . ”.

### Input:

{passage}

### Response:

This prompt, or other similar type of prompt, may be implemented for each protected attribute reference identified in the one or more corpora 290 identified by the taxonomy matching engine 222 based on the protected attribute taxonomy data structure 212, where the {passage} is the portion of text in which the instance of the protected attribute reference was identified. Thus, for each instance identified, the LLM will return a response as to whether the instance is referencing a person, not referencing a person, or is not able to be determined. For the latter result, depending on the desired implementation, these instances may be considered references to persons or references to non-persons, depending on whether the implementation is to be more or less sensitive to protected attribute references in natural language text.

As a result, instances of keywords from the protected attribute taxonomy data structure 212 in the corpora 290 may be identified that are specifically referencing protected attributes, as opposed to the instances referencing non-protected attributes, i.e., other than persons. The instances referencing protected attributes may be compile them into training data which is then evaluated by a LLM based regard classification engine 226 to determine the regard classification for each instance, e.g., negative, neutral, or positive regard. Similar to the prompt above, the LLM based regard classification engine 226 may be provided with a prompt having an instruction specifying that the LLM is to determine the regard classification (positive, negative, neutral) of a given instance of a protected attribute keyword reference in text samples from the corpora 290. The LLM may return a classification for each instance as to whether it represents a positive, negative, or neutral regard to the particular protected attribute of an entity, e.g., human being/person. The results of the LLM may be used by the regard annotation engine 228 to annotate the instance in the text.

The annotated instances may be compiled into the training data for training a regard classifier engine 240. That is, the training data comprises the instances of keywords from the protected attribute taxonomy data structure 212 in the corpora 290 which have been determined by the words sense disambiguation engine 224 to be referencing a person or human being, and are annotated with regard annotations specifying whether the reference to the protected attribute by the keyword instance is a positive, negative, or neutral regard of the protected attribute of the person or human being. This training data is provided to the regard classifier training engine 230 to train the regard classification engine 240 to perform regard classifications in subsequent text processed by the trained regard classification engine 240.

The regard classifier training engine 230 executes machine learning training on the regard classification engine 240 using the training data generated by the protected attribute detection and annotation engine 240. This regard classification engine 240 is a smaller scale, fine-tuned machine learning computer model as opposed to the large scale LLM used for LLM based regard classification engine 226. Thus, the trained classification engine 240 requires less resource sand computation time to perform regard classification on subsequently received text than the large scale LLM. The training data trains the regard classification engine 240 by causing the regard classification engine 240 to proper classify the training data samples to have the regard classifications corresponding to the regard annotations generated by the regard annotation engine 228. The machine learning training involves multiple iterations or epochs of inputting training data into the classification computer model of the regard classification engine 240, generating an output, comparing the output to the regard annotation associated with the input, and determining a loss. Machine learning logic is then used to make adjustments to the classification computer model to reduce this loss between the classification computer model's output and the regard annotation. This process is repeated until a convergence criterion is reached, e.g., a predetermined number of iterations have occurred, a predetermined threshold level of accuracy is achieved, or the like.

Once trained in this manner, the regard classification engine 240 may be used in place of the LLM based regard classification engine 226 to perform regard classification of subsequent text inputs, such as the training data samples from the training dataset 272. That is, during runtime operation, after training of the regard classification engine 240, the protected attribute taxonomy data structure 212, with its corresponding keywords and definitions, may again be used to identify instances of keywords in text, such as text of training data samples in training data 272 for training a computer model, e.g., language model (LM) or large language model (LLM) 282 of LLM source computing system 280. The keyword instances may again be processed using WSD and the WSD engine 224 to differentiate instances that are protected attribute references and instances that are non-protected attribute references. For the protected attribute references, the trained regard classification engine 240 may then evaluate each protected attribute reference instance to classify the instance as to whether it represents a positive, negative, or neutral regard for the protected attribute. The instance may also be annotated by the regard annotation engine 228 with a regard annotation. Thus, each reference to a protected attribute in the training dataset 272 may be identified and annotated as to its regard for the protected attribute of an entity, e.g., positive, negative, or neutral.

Having annotated the training dataset 272 with regard annotations, the regard distribution and balancing engine 250 may generate a distribution of regard for each protected attribute in the protected attribute taxonomy data structure 212. The distribution may then be input and used by the regard distribution and balancing engine 250 to determine modification or changes to make to the training dataset to mitigate undesirable biases or regard in the training dataset with regard to the protected attributes. For example, modifications may be performed by identifying regard annotations in the training dataset that correspond to unwanted biases and down-sample those portions of the training dataset having such regard annotations, e.g., removing training data samples having negative regard for a protected attribute, so as to achieve a balance in the regard for a particular protected attribute. This may be performed across a subset or all such protected attributes. The actual down-sampling or other modifications to the training dataset may be executed by the bias mitigation engine 260 which performs the modifications and generates a balanced training dataset 262.

The balanced training dataset 262 may be stored in the training data source computing system 270 as an alternative or additional training dataset that may be used to train machine learning computer models, such as LLM 282. In addition, the balanced training dataset 262 may be provided to machine learning training logic of the LLM source computing system 280 (not shown) for training the machine learning computer model, e.g., LLM 282, to perform corresponding tasks. For example, this balanced training dataset 262 may be used to train the LLM 282 without introducing unwanted bias into the trained LLM 282. Thus, the training of the machine learning computer model, e.g., LLM 282, is improved by removing unwanted bias in the training dataset 272, to generate a balanced training dataset 262 used to train to machine learning computer model, resulting in a trained machine learning computer model that has minimized or eliminated unwanted bias in its operation with regard to protected attributes.

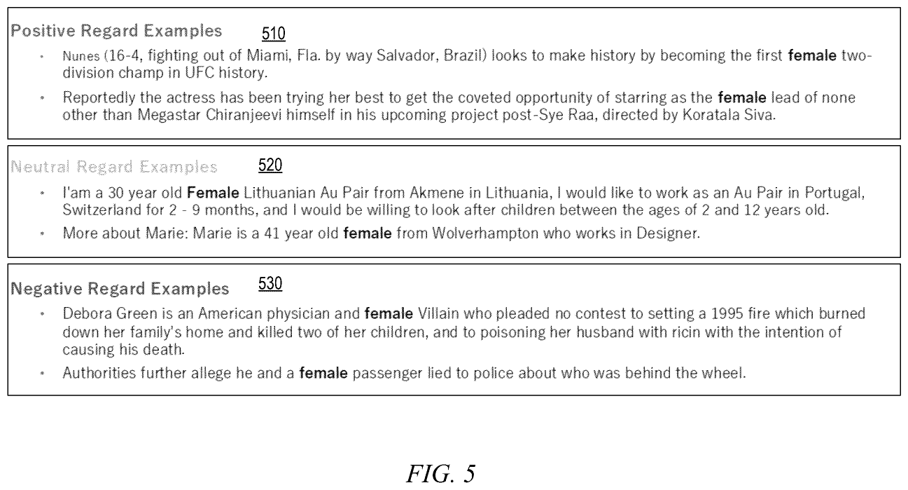

As discussed above, the illustrative embodiments annotate text having instances of keywords from the protected attribute taxonomy data structure 212, and which have been determined through WSD to be referencing protected attributes of an entity. The annotations are regard annotations that indicate whether the instance indicates a positive, negative, or neutral regard to the protected attribute. This results in different sets of texts for each of these different regard classifications, i.e., positive, negative, or neutral. FIG. 5 is an example diagram of examples of positive, neutral, and negative regard with regard to a protected attribute in accordance with one illustrative embodiment. As can be seen in FIG. 5, the examples comprise portions of text which may be compiled into a training dataset for training a regard classification engine 240. The first portion 510 comprises sentences where the protected attribute keyword “female” is present and the regard annotation is positive. The second portion 520 comprises sentences where the protected attribute keyword “female” is present and the regard annotation is neutral. The third portion 530 comprises sentences where the protected attribute keyword “female” is present and the regard annotation is negative. By training the regard classification engine 240 with such examples, the regard classification engine 240 is trained to distinguish between positive, neutral, and negative regard sentences and apply that learning to new text, such as the training dataset samples. The distribution of such regard classifications may then be determined for a training dataset and modifications made to balance the training dataset, minimize negative regard in the training dataset by using down-sampling, or otherwise minimize or eliminate unwanted bias in the training dataset.

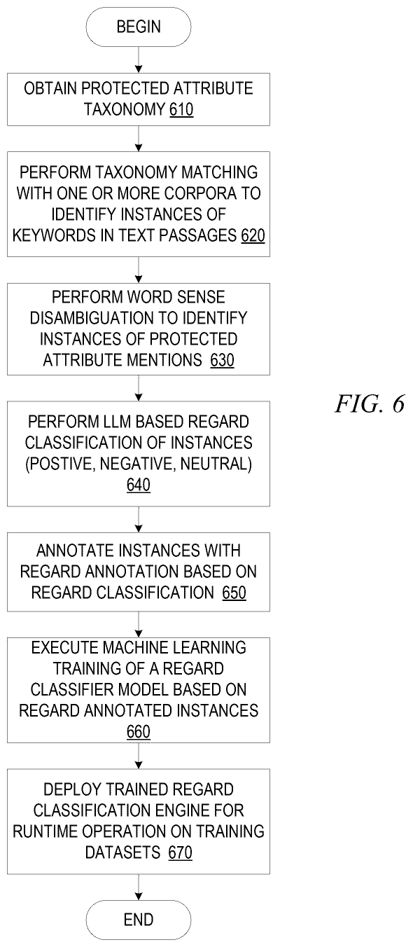

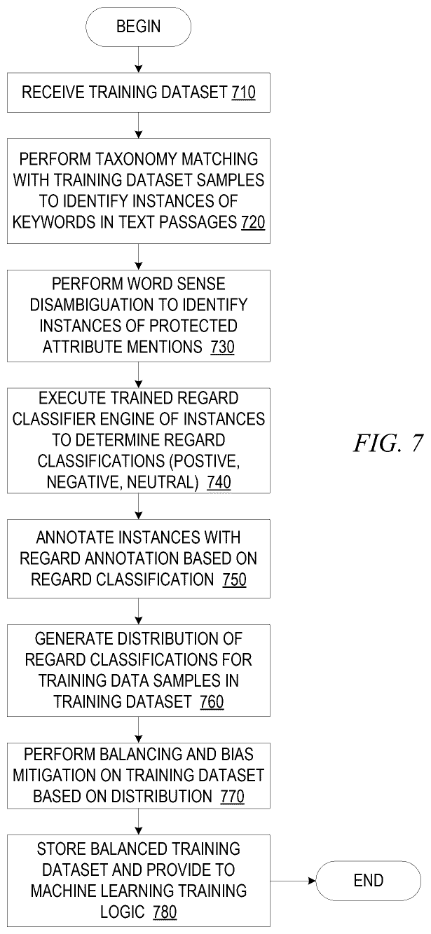

FIGS. 6 and 7 are flowcharts outlining example operation for performing training a regard classifier engine and performing bias analysis and mitigation in accordance with one or more illustrative embodiments. It should be appreciated that the operations outlined in FIGS. 6 and 7 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 6 and 7, and may, in some cases, make use of the results generated as a consequence of the operations set forth in FIGS. 6 and 7, the operations in FIGS. 6 and 7 themselves are specifically performed by the improved computing tool in an automated manner.

As shown in FIG. 6, the operation starts with the obtaining or building of a protected attribute taxonomy (step 610). The protected attribute taxonomy comprises keywords and definitions for one or more protected attributes. The protected attribute taxonomy may be a refinement of an initial taxonomy by computing and filtering the initial taxonomy based on a frequency of bias metric, a regard-plus-frequency of bias metric, or the like, for example.

The protected attribute taxonomy used to perform taxonomy matching with one or more corpora of text passages to identify instances of the keywords present in the text passages (step 620). Word sense disambiguation is performed on the instances to distinguish protected attribute mentions from non-protected attribute mentions (step 630). The resulting protected attribute mention instances are input to an LLM based regard classification engine to determine, for each instance of a protected attribute mention, a corresponding regard classification for that instance, e.g., positive, negative, or neutral (step 640). The instances are annotated with a regard annotation based on the regard classification and compiled into a training dataset for training a regard classification engine, i.e., a classifier computer model trained specifically to perform regard classification of input text passages (step 650).

A machine learning training of a regard classifier computer model of the regard classification engine is then performed based on the training dataset (step 660). The resulting trained regard classifier computer model is then deployed for runtime operation on training datasets to perform unwanted bias regard classification (step 670). The operation then terminates.

With regard to FIG. 7, the operation starts by receiving a training dataset that is to be evaluated for unwanted bias (step 710). The training data samples are matched with keywords in the protected attribute taxonomy to identify instances of the keywords present in the text passages (step 720). Word sense disambiguation is performed on the instances to distinguish protected attribute mentions from non-protected attribute mentions (step 730). The resulting protected attribute mention instances are input to the trained regard classification engine to determine, for each instance of a protected attribute mention, a corresponding regard classification for that instance, e.g., positive, negative, or neutral (step 740). The instances are annotated with a regard annotation based on the regard classification (step 750).

A distribution of the regard classification for training data samples in the training dataset is generated (step 760). Balancing and bias mitigation logic is then executed based on the generated distribution to remove unwanted bias from the training dataset (step 770) and achieve a desired balance of positive, negative, and neutral instances of protected attribute mentions in the training dataset. In some cases this may involve performing a down-sampling of negative regard instances in the training dataset. The resulting balanced training dataset is then stored for use in training a machine learning computer model and/or provided to machine learning training logic for training a machine learning computer model (step 780). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

1. A method for accurately detecting various protected attributes, classifying regard toward each attribute, and balancing the regard toward each attribute, the method comprising:
obtaining a taxonomy of protected attributes with associated keywords;
executing a keyword matching operation in a first dataset to detect instances of the keywords;
executing a regard classification on each instance of the keywords to classify a regard towards a corresponding protected attribute, wherein the regard classification is one of a positive regard, a negative regard, or a neutral regard;
annotating each instance of the keywords with a regard annotation corresponding to the regard classification for that instance, to generate a regard annotated dataset; and
executing a bias analysis and balancing of regard classification distributions of a second dataset to mitigate undesirable biases based on the regard annotated dataset.

2. The method of claim 1, wherein the second dataset is a training dataset for training a machine learning computer model.

3. The method of claim 2, wherein the machine learning computer model is a large language model (LLM).

4. The method of claim 2, wherein executing the bias analysis and balancing of regard classification comprises down-sampling training data samples in the training dataset having a regard annotation indicating a negative regard.

5. The method of claim 2, wherein executing the bias analysis and balancing of regard classification comprises balancing a number of first training data samples in the training dataset having regard annotations that indicate a positive regard, and a number of second training data samples having regard annotations that indicate a negative regard, to have approximately a same number of training data samples.

6. The method of claim 1, further comprising executing a word sense disambiguation on the instances of the keywords in the first dataset to distinguish between first instances where the keyword is referencing a protected attribute corresponding to the keyword, and second instances where the keyword is not referencing a protected attribute corresponding to the keyword, and wherein the second instances are removed as instances with regard to the regard classification and the regard annotation.

7. The method of claim 1, further comprising training a regard annotation classification machine learning computer model based on the regard annotated dataset to classify input text into a regard classification, wherein the regard classification is one of a positive regard, negative regard, or neutral regard.

8. The method of claim 1, wherein the regard classification executed on each instance of the keywords is executed by inputting a prompt to a large language model (LLM) to cause the LLM to specify a regard classification for an input text passage.

9. The method of claim 1, wherein obtaining the taxonomy comprises:
obtaining an initial taxonomy of protected attributes and keywords;
evaluating a frequency of bias with regard to each keyword of each protected attribute in the initial taxonomy; and
filtering the initial taxonomy based on the frequency of bias to generate the taxonomy of protected attributes.

10. The method of claim 9, further comprising evaluating a regard classification for each keyword of each protected attribute in the initial taxonomy, wherein the filtering is based on a regard-plus-frequency bias metric.

11. A computer program product comprising:
one or more computer-readable storage media; and
program instructions stored on the one or more computer-readable storage media to perform operations comprising:
obtaining a taxonomy of protected attributes with associated keywords;
executing a keyword matching operation in a first dataset to detect instances of the keywords;
executing a regard classification on each instance of the keywords to classify a regard towards a corresponding protected attribute, wherein the regard classification is one of a positive regard, a negative regard, or a neutral regard;
annotating each instance of the keywords with a regard annotation corresponding to the regard classification for that instance, to generate a regard annotated dataset; and
executing a bias analysis and balancing of regard classification distributions of a second dataset to mitigate undesirable biases based on the regard annotated dataset.

12. The computer program product of claim 11, wherein the second dataset is a training dataset for training a machine learning computer model.

13. The computer program product of claim 12, wherein the machine learning computer model is a large language model (LLM).

14. The computer program product of claim 12, wherein executing the bias analysis and balancing of regard classification comprises down-sampling training data samples in the training dataset having a regard annotation indicating a negative regard.

15. The computer program product of claim 12, wherein executing the bias analysis and balancing of regard classification comprises balancing a number of first training data samples in the training dataset having regard annotations that indicate a positive regard, and a number of second training data samples having regard annotations that indicate a negative regard, to have approximately a same number of training data samples.

16. The computer program product of claim 11, further comprising executing a word sense disambiguation on the instances of the keywords in the first dataset to distinguish between first instances where the keyword is referencing a protected attribute corresponding to the keyword, and second instances where the keyword is not referencing a protected attribute corresponding to the keyword, and wherein the second instances are removed as instances with regard to the regard classification and the regard annotation.

17. The computer program product of claim 11, further comprising training a regard annotation classification machine learning computer model based on the regard annotated dataset to classify input text into a regard classification, wherein the regard classification is one of a positive regard, negative regard, or neutral regard.

18. The computer program product of claim 11, wherein the regard classification executed on each instance of the keywords is executed by inputting a prompt to a large language model (LLM) to cause the LLM to specify a regard classification for an input text passage.

19. The computer program product of claim 11, wherein obtaining the taxonomy comprises:
obtaining an initial taxonomy of protected attributes and keywords;
evaluating a frequency of bias with regard to each keyword of each protected attribute in the initial taxonomy; and
filtering the initial taxonomy based on the frequency of bias to generate the taxonomy of protected attributes.

20. A computer system comprising:
a processor set;
one or more computer-readable storage media; and
program instructions stored on the one or more computer-readable storage media to cause the processor set to perform operations comprising:
obtaining a taxonomy of protected attributes with associated keywords;
executing a keyword matching operation in a first dataset to detect instances of the keywords;
executing a regard classification on each instance of the keywords to classify a regard towards a corresponding protected attribute, wherein the regard classification is one of a positive regard, a negative regard, or a neutral regard;
annotating each instance of the keywords with a regard annotation corresponding to the regard classification for that instance, to generate a regard annotated dataset; and
executing a bias analysis and balancing of regard classification distributions of a second dataset to mitigate undesirable biases based on the regard annotated dataset.
